(19) United States
(12) Patent Application Publication
(10) Pub. No.: US 2002/0035603 A1
(43) Pub. Date: Mar. 21, 2002

(54) Method for collaborative-browsing using transformation of URL

(76) Inventors: Jae-Young Lee, Taejon (KR); Ji-Yong Kim, Taejon (KR); Doo-Hyeon Kim, Taejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/752,672

(22) Filed: Dec. 28, 2000

(30) Foreign Application Priority Data
Sep. 20, 2000 (KR) 2000-55139

(51) Int. Cl. G06F 15/16

(52) U.S. Cl. 709/205

(57) ABSTRACT

There are provided a collaborative browsing method for allowing multiple users to see a web text simultaneously through transformation of URL and a recording medium for recording a program for realizing the method, which is able to be read by a computer. The collaborative browsing method applied to a collaborative browsing system, comprises: a first step of searching for a web page that a user requests, transforming the URL of the searched web page, storing it, and then transmitting the web page to the user; and a second step of sending the transformed URL of the web page to other users who participate in the same session in which the user is joining, and transmitting the stored web page to the other users if they request it.

### FIELD OF THE INVENTION

The present invention relates to a collaborative browsing method and, more particularly, to a collaborative browsing method for allowing multiple user to see a web text simultaneously through transformation of URL (Uniform Resource Locator) and a recording medium for recording a program for realizing the method, which is able to be read by a computer.

### DESCRIPTION OF THE PRIOR ART

Users can browse through web sites for information they want to attain through the Internet. A basic method for searching the web sites for information is that the users themselves perform the information search. Specifically, upon a user sending a request for information to a web site via a web browser, the web server of the web site searches for the requested information and transmits it in HTML format to the web browser. One of the characteristics of this method is “hyper-text link” included in a detected web page, which provides the user searching for information with a method of “navigation” from one web page to another page.

To provide services to users (or consumers) through the Internet requires a mechanism of synchronizing web page navigation among plural wet browsers which is performed on multiple user terminals. A conventional web page navigation synchronizing method is passive in such a way that a user who commands navigation informs other users that what URL he is seeing, what data he is inputting and information about the navigation using a separate communication channel such as telephone. This passive process has a problem that the other users may easily perform erroneous operations because they should execute operations under the voice control of the user who commands the navigation. In addition, the above conventional process is not suitable for client support through web page navigation because it is labor-intensive.

One of solutions to the problems of the passive process is to install an observation program in the web site. That is, when a command terminal sends a request for a URL to a web site, the observation program of this web site receives the requested URL and broadcasts this URL to all terminals participated such that the terminals can load the web page corresponding to the URL sent from the command terminal on their web browser. However, this method cannot precisely observe URLs because requests are locally settled in case that the command terminal loads a web page from the cache of the web browser or a proxy server and the observation program cannot observe all of requests from the command terminal when URL is not sent to corresponding web site.

Another method for solving the problems of the aforementioned passive process is to install the observation program together with a command browser of the command terminal. Specifically, while the observation program is communicating with the command web browser, when the command browser requests a web page, the observation program sends the URL of the requested web page to a server. The server transmits the URL to the observation program installed together with a subordinate browser of a subordinate terminal. The observation program of the subordinate terminal instructs the corresponding browser to load the web page corresponding to the transmitted URL.

However, this method must design and install the observation program is capable of communicating with the command browser and subordinate browser without cease. Since Netscape, Microsoft, Sun microsystem, IBM, etc. are selling different web browsers, a program developer is required to know the structure or individual web browser in order to design and develop the observation program. Further, when the individual web browser is updated, the observation program should be also updated. Moreover, because the web browsers have different web browser interface mechanisms, the observation program for a certain web browser cannot be easily potted to other web browsers. In addition, users are not happy for installation of the observation program that collects information about all the web sites they visit and reports it to them.

### SUMMARY OF THE INVENTION

It is, therefore, an object of the present invention to provide a collaborative browsing method for allowing multiple users to see a web text simultaneously through transformation of URL (Uniform Resource Locator) and a recording medium for recording a program for realizing the method, which is able to be read by a computer.

Specifically, the present invention provides a collaborative browsing method using transformation of URL, in which a collaborative browsing server receives the URL of a web page a user want to search for from the user, searches for the web page, transforms the URL of the web page, transmits the searched web page to the web browser of the user and sends the transformed URL of the web page to other users who participate in this session. The present invention also provides a recording medium for recording a program for realizing this method, which can be read by a computer.

To accomplish the object of the present invention, there is provided a collaborative browsing method applied to a collaborative browsing system, comprising: a first step of searching for a web page that a user requests, transforming the URL of the searched web page, storing it, and then transmitting the web page to the user; and a second step of sending the transformed URL of the web page to other users who participate in the same session in which the user is joining, and transmitting the stored web page to the other users if they request it.

To accomplish the object of the present invention, there is also provided a recording medium capable of being read by a computer, the recording medium recording a program for executing a first function of searching for a web page that a user requests, transforming the URL of the searched web page, storing it and then transmitting it to the user, and a second function of sending the stored web page to other users who are participating in the same session in which the user is joining and transmitting the stored web page to the other users if they request it, the program executing the first and second functions on a collaborative browsing server having a processor for collaborative browsing.

### BRIEF DESCRIPTION OF THE DRAWINGS

FIG. 1 illustrates a collaborative browsing environment to which the present invention is applied;

FIG. 2 illustrates an embodiment of the configuration of the client/server of a collaborative browsing system to which the present invention is applied;

FIG. 3 illustrates an embodiment of a collaborative browsing method using transformation of URL according to the present invention;

FIG. 4 is a flow chart showing an embodiment of collaborative browsing through cession opening or cession joining according to the present invention;

FIG. 5 is a flow chart showing an embodiment of processing of a browsing request performed by a collaborative browsing server according to the present invention; and

FIGS. 6A to 6D exemplarily show execution of the collaborative browsing according to the present invention.

### DETAILED DESCRIPTION OF THE PREFERRED EMBODIMENT

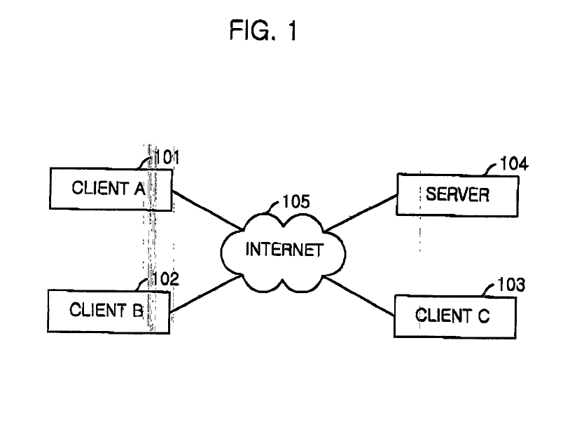

Reference will now be made in detail to the preferred embodiments of the present invention, examples of which are illustrated in the accompanying drawings. FIG. 1 illustrates a collaborative browsing environment to which the present invention is applied. All the functions of collaborative browsing are defined to operate in a client/server environment, and all of sessions are managed by at least one server 104. All of web browsers which operate on terminals 101, 102 and 103 capable of being connected to the Internet 105 and support Java operate as clients of a collaborative browsing system. All the clients are connected to the collaborative browsing server 104 through the Internet 105.

As shown in FIG, 1, in case where three clients 101, 102 and 103 participate in a session, for example, the server 104 receives a request for browsing from the client 101 to carry out it and transmits the browsing event to other clients 102 and 103. Then, the clients 102 and 103 receive a URL and load it.

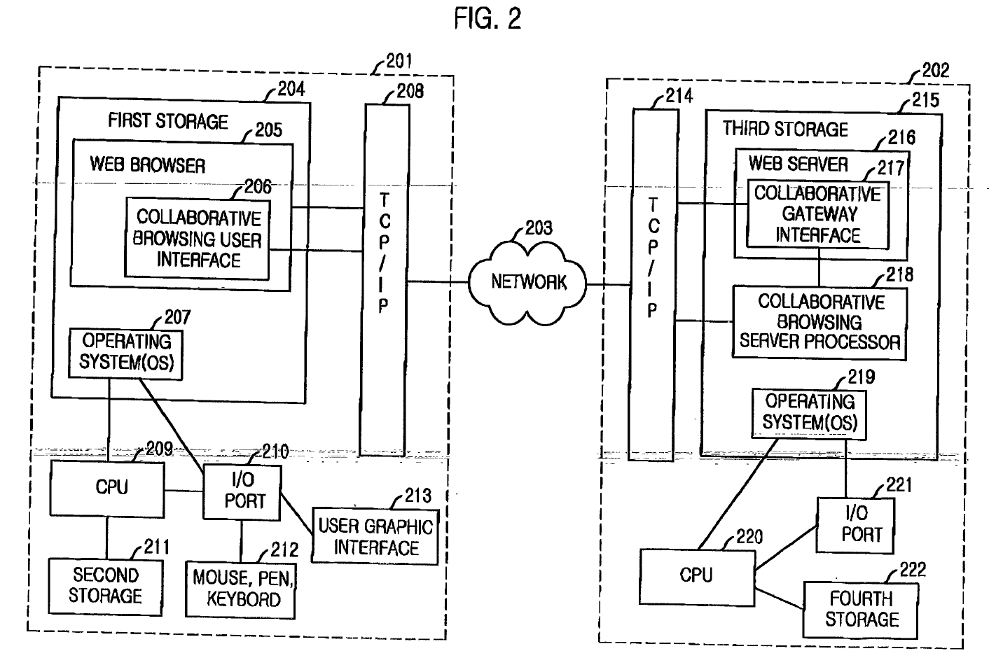

FIG. 2 illustrates an embodiment of the configuration of the client/server of a collaborative browsing system to which the present invention is applied. Reference numeral 201 represents a collaborative browsing client terminal and 202 represents a collaborative browsing server.

The collaborative browsing client 201 is a computer having a central processing unit (CPU) 209, a second storage 211 such as hard disk, a first storage 204 corresponding to a main memory, a transmission control protocol/Internet protocol (TCP/IP) stack 208, and an input/output (I/O) interface 201. The I/O interface 210 allows an input device 212 such as a mouse, keyboard, pen, etc. to be processed by the CPU 209 and an operating system 207 and operates a graphic user interface 213 on the client. The TCP/IP protocol stack 208 enables the client 201 to communicate with other terminals on the Internet. A web browser 205 operating on the client 201 has a collaborative browsing user interface 206, as shown in FIG. 2.

The collaborative browsing server 202 is a computer server including a CPU 220, a fourth storage 222, a third storage 215 corresponding to a main memory, a TCP/IP stack 214 and an I/O interface 221. The collaborative browsing server 202 also has a web server 216 having a common gateway interface (CGI) 217 through which it communicates with the collaborative browsing server processor.

A user who wants to use the collaborative browsing system operates the web browser 205 on the collaborative browsing terminal 201 to connect with the collaborative browsing server 202 and then executes the collaborative browsing user interface 206. The collaborative browsing user interface 206 loads a session list managed by a processor 218 of the collaborative browsing server. The user selects a session he wants to join in from the session list to participate therein or generates a new session.

Furthermore, a collaborative browsing system includes a collaborative browsing server processor for retrieving a web page from a target web server through HTTP (HyperText Transfer Protocol) to process the web page and store the processed web page therein, a web server provided with a storage memory and a common gateway interface (CGI) for being communicated with the collaborative browsing server processor and a web browser, provided with a communication module, two communication channels, for communicating with the web server through HTTP and for receiving/sending TCP/IP socket through the second communication channel to communicate the communication module and the collaborative browsing server processor, respectively. Here, the collaborative browsing server processor transfers information from the communication module to a communication module of other users.

In addition, a collaborative browsing server comprises a collaborative browsing server processor for communicating with a collaborative browsing client, a web server incorporating therein a CGI for communicating with the collaborative browsing server processor and an operation system for operating the web server.

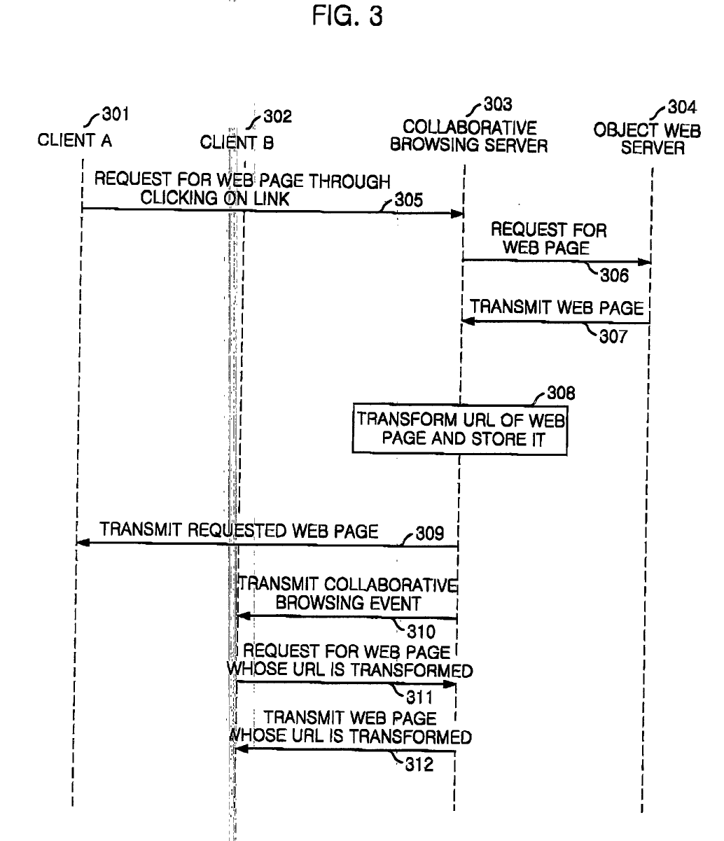

FIG. 3 illustrates an embodiment of a collaborative browsing method using transformation of URL according to the present invention. This shows a procedure of processing a request from a user in the collaborative browsing system of FIG. 2.

Referring to FIG. 3, when the user of a client A 301 clicks on a link to request a web page, this request is transmitted to a collaborative browsing server 303 via the web browser in HTTP (HyperText Transfer Protocol) that is a standard protocol (305). The collaborative, browsing server 303 which has received the request detects the URL of the requested web page and requests a web server 304 corresponding to the detected URL to send the web page (HTML text) of the URL thereto (306). The web server 304 transmits the corresponding web page to the collaborative browsing server 303 (307).

The collaborative browsing server 303 which has received the web page (HTML text) transforms its URL into the URL of the collaborative browsing server to store it together with the web page (308) and then sends the requested web page to the client A (309). The collaborative browsing server 303 which finished the web page transmission sends the collaborative browsing event (that is, the transformed URL of the web text requested by the client A) to the other client B 302 who is joining in the session (310). When the other client B 302 requests the web page whose URL has been already transformed and stored in the collaborative browsing server 303 (311), the collaborative browsing server 303 delivers the web page whose URL has been transformed to the client B (312).

In other words, the present invention allows a plurality of users to see the web page of the some URL simultaneously through multiple web browsers operating on multiple client terminals. The users execute the web browsers on their terminals connected to a network to connect to the collaborative browsing server and then generate a desired session or join in a session previously created, to collaboratively perform web page browsing together. For this, the web browser of each user must download a component (Java applet, active control, etc.) supporting the collaborative browsing from the server and the server should has a device for transforming URLs of web pages and distributing various messages generated from the users.

All the web page browsing operations generated after the users connect to the collaborative browsing server to join in a session are carried out by the collaborative browsing server, and information about this is transmitted in real time to all the users who participate in the session through the collaborative browsing server. The component that received a collaborative browsing message commands to the web browsers of the users who participate in the session to load corresponding URL so that the web browsers of all the participants of the session load the web page corresponding to the same URL all the time.

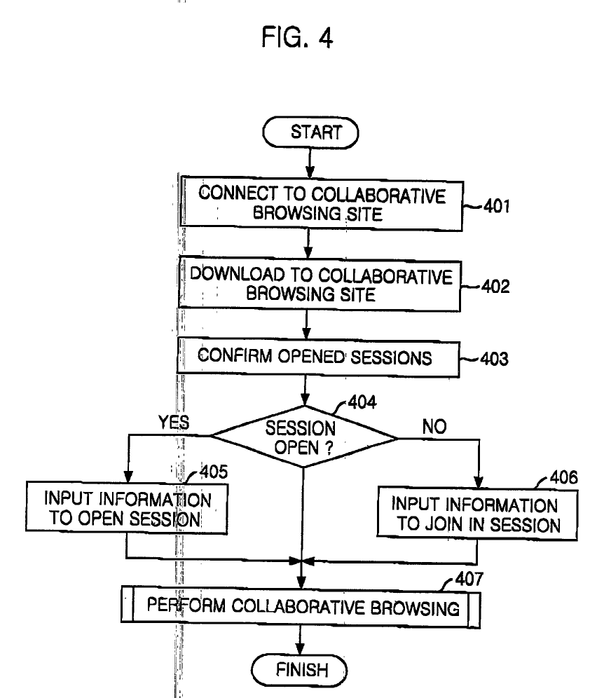

FIG. 4 is a flow chart showing an embodiment of collaborative browsing through cession opening or cession joining according to the present invention. This shows a procedure in which a user of the collaborative browsing system connects to the collaborative browsing server to generate a session or join in a session previously created, performs collaborative browsing and then finishes it. The user connects to a collaborative browsing site (401), and downloads a collaborative browsing component created using the Java applet, active control, etc. (402). Then, the user confirms opened sessions indicated on the collaborative browsing component (403) and decides if he opens a new session (404). According to the result of the decision, the user inputs information to generate the new session (406) or inputs information to join in a session previously created (406), to carry out collaborative browsing (408) and finish it.

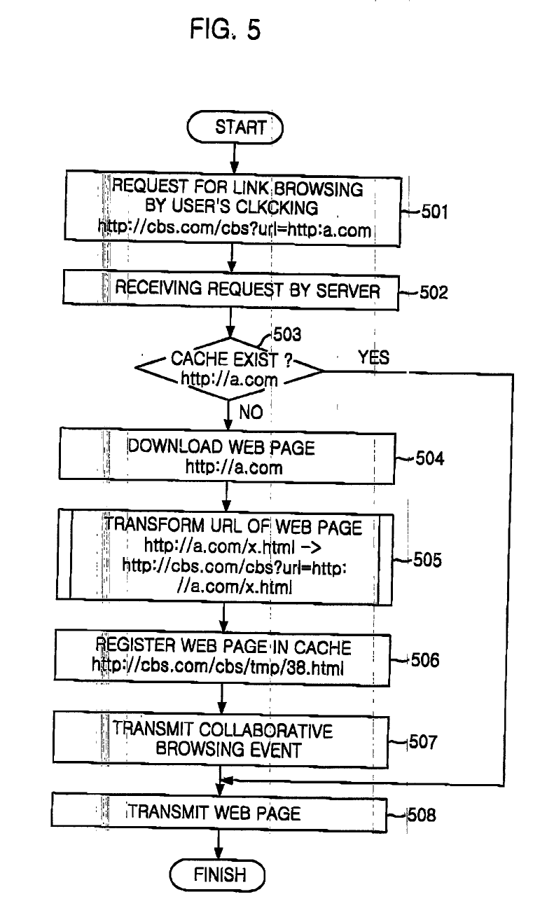

FIG. 5 is a flow chart showing an embodiment of processing of a request for browsing performed by the collaborative browsing server according to the present invention. This shows a procedure in which the collaborative browsing server processes a request for link browsing from a user who makes the request through clicking. Here, the collaborative browsing server is called “cbs.com” and a server that the user wants to browse in is called “a.com”. The user clicks on a link represented as http://cbs.com/cbs?url=http://a.com to request browsing in this link (501). The collaborative browsing server that has received the request (502) confirms if the URL (http://a.com) corresponding to the request exists in its cache (503). When it is confirmed that the URL does not exist, the collaborative browsing server downloads the web pate (HTML text) corresponding to the URL from the server (a.com) the user wants to browse in (504), transforms the link indicated by http://a.com/x.html in the downloaded page into http://.cbs.com/cbs?url=http://a.com/x.html (that is, transforms the URL of the web page) (505), registers it in the cache (506), and then transmits the collaborative browsing event (the transformed URL of the web text) to other clients who are joining in the same session (507). Thereafter, the collaborative browsing server sends the web page to the first client to request it (508), completing the procedure.

On the other hand, when it is confirmed that the URL exists in the cache (503), the collaborative browsing server transmits the web page corresponding to the URL to the client (508) and finishes the procedure.

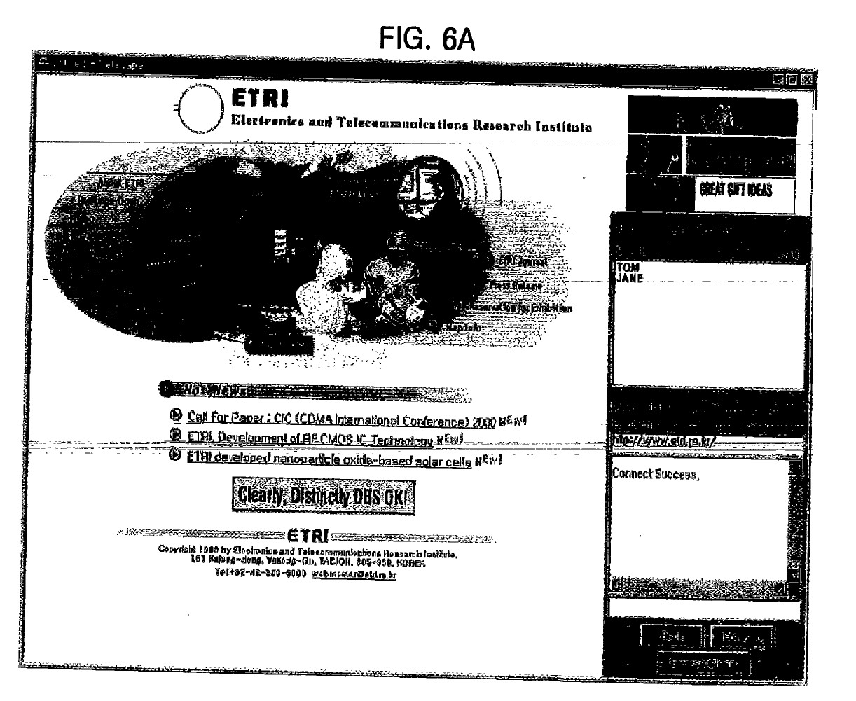

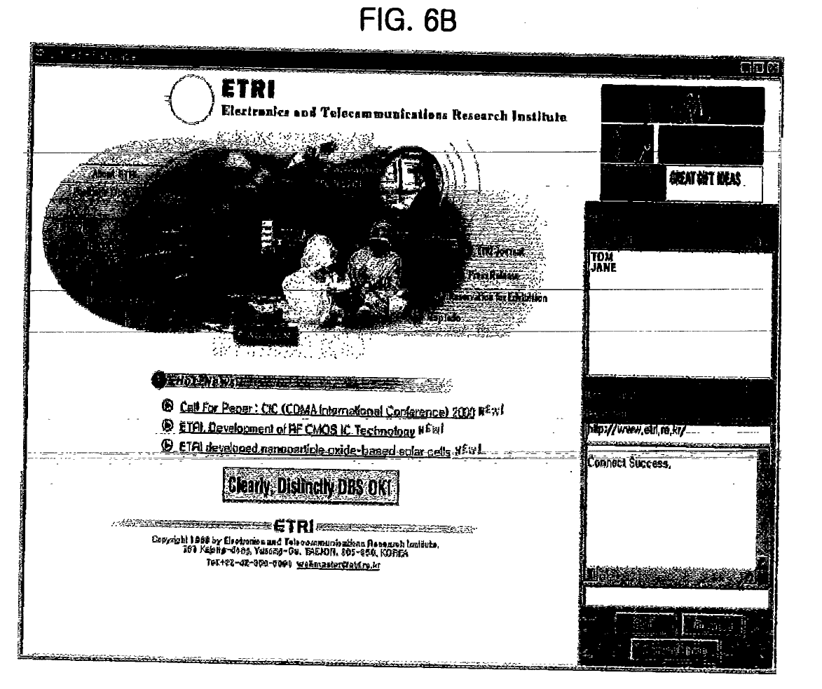

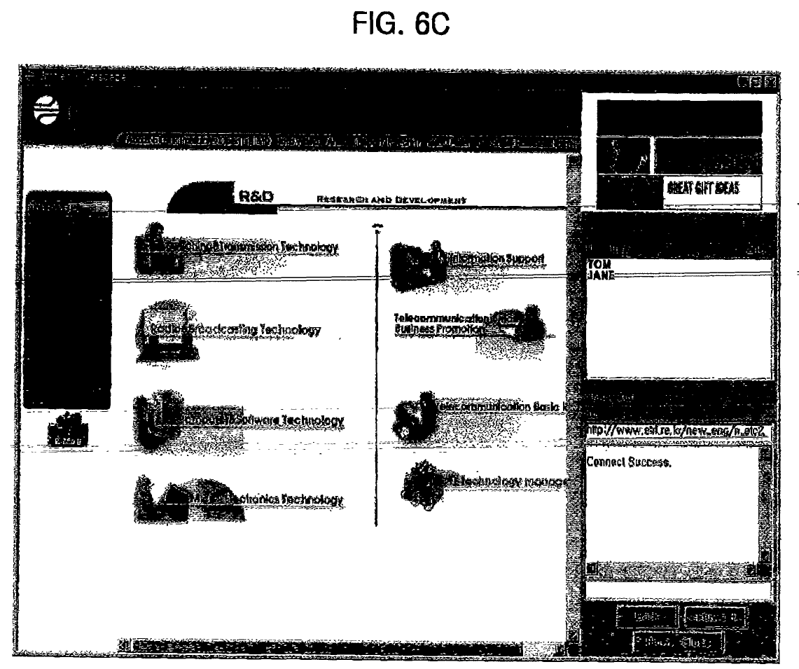

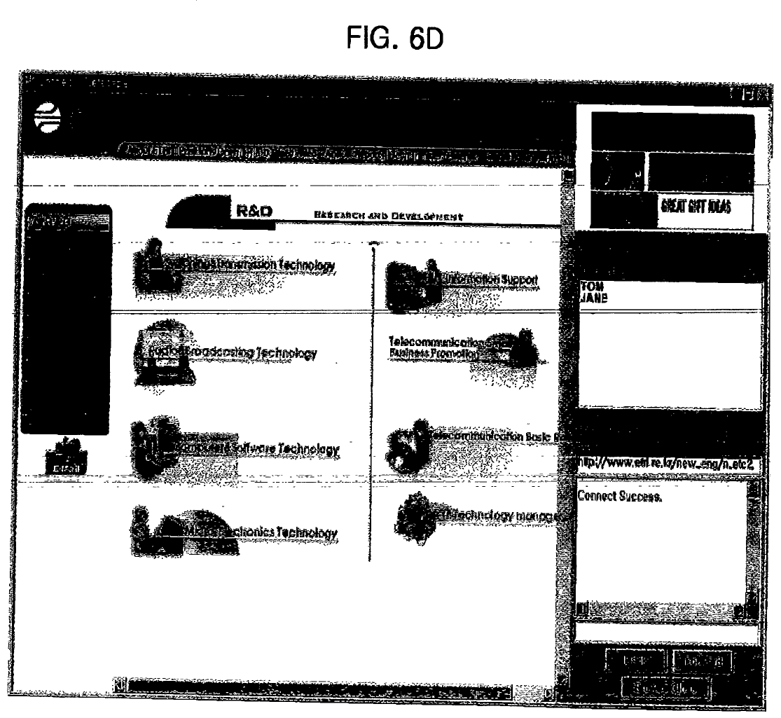

FIGS. 6A to 6D exemplarily show execution of the collaborative browsing according to the present invention. Referring to FIGS. 6A to 6D, a user 1 (FIG. 6A) and a user 2 (FIG. 6B) who participate in a session are browsing in the same web page (HTML text) having the URL of http://www.etri.re,kr. Here, when the user 1 clicks on the link R&D in the web page, of the web browsers of the users 1 and 2 who join in the session are changed into the corresponding URL, displaying the same web page corresponding to the URL to the user 1 (FIG. 6C) and user 2 (FIG. 6D).

As described above, according to the present invention, three or more of Internet users can easily collaboratively browse through web pages using the web browsers supporting Java script and Java applet without any separate installation. When a user clicks on a hyper-link displayed in the web browser to browse through web sites as in the case of general web site browsing, this operation is immediately transmitted to other users, to display the web page corresponding to the clicked hyper-link to the browsers of all the users. The present invention can be used in a field such as remote education in which teachers and students participate together.

While the present invention has been particularly shown and described with reference to preferred embodiments thereof, it will be understood by those skilled in the art that various changes in form and details may be made therein without departing from the spirit and scope of the invention.

What is claimed is:

1. A collaborative browsing method applied to a collaborative browsing system, comprising:
a first step of searching for a web page that a user requests, transforming the URL of the searched web page, storing it, and then transmitting the web page to the user; and
a second step of sending the transformed URL of the web page to other users who participate in the same session in which the user is joining, and transmitting the stored web page to the other users if they request it.

2. The collaborative browsing method as claimed in claim 1, wherein the first step comprises:
a third step in which a collaborative browsing server receives the request for web page search from the user and requests the server of the requested web page to send it thereto;
a fourth step in which the collaborative browsing server transforms the URL of the web page sent from its server into a URL of the collaborative browsing server and stores it; and
a fifth step in which the collaborative browsing server transmits the web page whose URL has been transformed to the user.

3. The collaborative browsing method as claimed in claim 1 or 2, wherein the second step comprises:
a sixth step in which the collaborative browsing server transmits the transformed URL of the web page to the participants of the session; and
a seventh step in which the collaborative browsing server sends the stored web page to the participants if they request it.

4. A recording medium capable of being read by a computer, the recording medium recording a program for executing a first function of searching for a web page that a user requests, transforming the URL of the searched web page, storing it and then transmitting it to the user, and a second function of sending the stored web page to other users who are participating in the same session in which the user is joining and transmitting the stored web page to the other users if they request it, the program executing the first and second functions on a collaborative browsing server having a processor for collaborative browsing.

5. A collaborative browsing system comprising:
a collaborative browsing server processor for retrieving a web page from a target web server through HTTP (HyperText Transfer Protocol) to process the web page and store the processed web page therein;
a web server provided with a storage memory and a common gateway interface (CGI) for being communicated with the collaborative browsing server processor; and
a web browser, provided with a communication module, a first and a second communication channels, for communicating with the web server through the first communication channel and for receiving/sending TCP/IP socket through the second communication channel to communicate the communication module and the collaborative browsing server processor, respectively.

6. The collaborative browsing system of claim 5, wherein the collaborative browsing server processor transfers information from the communication module to a communication module of other users.

7. The collaborative browsing system of claim 5, wherein the first communication channel transfers information by using HTTP.

8. A collaborative browsing server comprising:
a collaborative browsing server processor for communicating with a collaborative browsing client;
a web server incorporating therein a CGI for communicating with the collaborative browsing server processor; and
an operation system for operating the web server.
